(19) United States
(12) Patent Application Publication
(10) Pub. No.: US 2013/0336630 A1
(43) Pub. Date: Dec. 19, 2013

(54) BACKDROP APPARATUS

(71) Applicant: STEVEN MARK LEVINSOHN, JOHANNESBURG (ZA)

(72) Inventor: STEVEN MARK LEVINSOHN, JOHANNESBURG (ZA)

(21) Appl. No.: 13/950,406

(22) Filed: Jul. 25, 2013

(30) Foreign Application Priority Data
Jul. 25, 2012 (ZA) 2012/06028

(51) Int. Cl. H04N 9/79

(52) U.S. Cl. CPC H04N 9/79
USPC 386/230

(57) ABSTRACT

The invention relates to a backdrop apparatus for use during recording or filming of an interview by way of an image capturing arrangement, the backdrop apparatus comprising an at least partly planar surface onto which is disposed an predetermined arrangement of communication zones which display communication data, wherein the arrangement of communication zones comprises at least one dynamic communication zone being operable to display a variable communication, and at least one static communication zone being operable to display a static communication. The invention further relates to a method of recording or filming an interview with the backdrop apparatus disposed behind the interviewer and/or interviewee.

### FIELD OF THE INVENTION

This invention relates to broadcasting. More particularly, the invention relates to a backdrop apparatus and to a method of filming an interview.

### BACKGROUND OF THE INVENTION

In stationary or mobile interview arrangements, there is often a planar backdrop apparatus with sponsors' communication data, such as advertising material, displayed thereon. Often the communication data is arranged in a matrix formation on the backdrop apparatus which is then included as a backdrop or background during interviews and/or other events, which interviews are filmed and/or recorded and transmitted to an audience. When viewed by the viewers, the backdrop apparatus, particularly the communication data provided thereon, forms part of the filming and is and is visible to the viewers.

Communication data, typically advertisements, displayed on a backdrop apparatus have commercial value as the broadcaster or transmitter of the interview or event can charge a consideration for the display of the advertisements associated with sponsors to a viewer(s).

The larger the audience viewing the transmitted event, which often comprises an interview or discussion, the higher the price is that can be charged for displaying an advertisement to an audience.

Conventional backdrop apparatuses usually display a plurality of advertisements, where the advertisements are static advertisements of the same or substantially similar composition, usually being printed onto a surface. A problem with this arrangement is that one advertisement or a plurality of advertisements associated with a first sponsor does not stand out from an advertisement or a plurality of advertisements associated with a second sponsor.

In effect, there is a lot of clutter amongst the communication data provided on conventional backdrop apparatuses and it is difficult for one to differentiate between communication data.

The present invention seeks at least to partially ameliorate the abovementioned problems and to provide a backdrop apparatus which may provide different opportunities to advertisers and sponsors.

### SUMMARY OF THE INVENTION

According to one aspect of the invention there is provided a backdrop apparatus for use during filming of an interview by way of an image display arrangement, the backdrop apparatus comprising:

an at least partly planar surface onto which is disposed an arrangement of communication zones which display communication data, wherein the arrangement of communication zones comprises:

at least one dynamic communication zone being operable to display a variable communication, and

at least one static communication zone being operable to display a static communication.

The variable communication may be an electronically variable communication.

The surface of the backdrop apparatus may be provided on a wall.

The wall may be collapsible.

The planar wall may be defined by any one of a substantially flat plane and a curved plane.

The geometric arrangement may be in the form of a matrix of communication zones. Alternatively, the geometric display may be in the form of any other type of geometric arrangement of communication zones, with at least some of the zones operable to display dynamic video content.

Conveniently, the backdrop apparatus comprises at least one proximity sensor to determine the presence of an interviewer and interviewee. The sensitivity of the proximity sensor may be adjustable for adjusting the range of interviewer and interviewee detection.

Conveniently, the backdrop apparatus comprises a plurality of proximity sensors. In use, the proximity sensors indicate the position of the interviewer and interviewee relative to the backdrop, which position is used to select the type and position of content displayed on the communication zones. The content displayed is thus movable about the communication zones, and in particular, movable when the interviewer, alternately, the interviewee moves.

The electronic display device may be in the form of a liquid crystal display, a light emitting diode display and a plasma display.

The electronic display may include a vertical synchronization interface, operable to synchronize the vertical scan signal of the electronic display and an external video camera with each other to stabilise the vertical scan signals.

The backdrop apparatus may include a display driver, operable to stream content to the at least one electronic display.

In one embodiment of the invention, the backdrop apparatus may include multiple electronic screens, and the content may thus be synchronized amongst the screens.

In another embodiment of the invention, in which the backdrop apparatus includes multiple electronic screens, the content may be unsynchronized.

The display driver may include storage means. The display driver may be in the form of a multi-channel media player. The media player may include a data interface. The data interface may be in the form of any one of an electrical interface and a wireless interface through which content can be streamed.

The media player may be operable to receive content in any one of real time and off-line. The media player may include a content scheduling arrangement, operable selectively to play pre-defined content at a particular time on a particular electronic display.

The dynamic content may include any one of logo's, advertisements and names.

The backdrop apparatus may include a power supply connectable to a mains electricity supply.

The power supply may be in the form of a rechargeable battery backup and inverter arrangement, operable to power the at least one electronic display and the display driver.

According to another aspect of the invention, there is provided a method of recording an interview, which includes

providing a backdrop apparatus as described;

arranging subjects to be recorded in front of the backdrop apparatus such that the backdrop apparatus fills the recording frame; and

recording the interview in front of the backdrop apparatus.

It is to be appreciated that the backdrop apparatus may fill a smaller portion of the recording frame than the full frame.

The invention will now be described by way of a non-limiting example only, with reference to the following drawings.

### DRAWINGS

In the drawings:

FIG. 1 shows a backdrop apparatus with static display zones;

FIG. 2 shows a backdrop apparatus in accordance with one aspect of the invention, with a dynamic advertisement zone in the form of an electronic display device;

FIG. 3 shows a backdrop apparatus with a plurality of dynamic advertisement zones and a media player;

FIG. 4 shows a block diagram of the media player; and

FIG. 5 shows another embodiment of a backdrop apparatus also in accordance with the invention.

### DETAILED DESCRIPTION OF THE INVENTION

In FIG. 1 reference numeral 90 refers to a backdrop apparatus. In the known prior art the backdrop apparatus 90 is manufactured of a light weight plastic or wooden backing 101, or of a vinyl material attached to a supporting backdrop apparatus structure or other suitable material.

It will be appreciated that in a preferred example embodiment, the backdrop apparatus may be a backdrop apparatus and in this regard reference will be made thereto.

In any event, an interviewer 102 interviews an interviewee 103 in front of the studio backdrop 90. The interview is often recorded or filmed by an image capturing arrangement (not shown) and broadcasted to an audience. An audio pickup of the conversation between the interviewer and the interviewee is made with the use of a microphone 104.

It will be appreciated that in this specification, the term “interview” includes an interview, a discussion a conversation or any other activity which takes place with a backdrop apparatus as a backdrop to the interview, typically with the backdrop apparatus being provided behind the person or people being interviewed such that it may be visible in the filming or recording of the interview by way of the image capturing arrangement.

When used in this invention, the terms “filming” and or “recording” includes filming and or recording of the interview by the image capturing arrangement which may include any device that is configured to capture an image or a series of images, and a camera comprises a film camera, video camera and/or recorder, whether digital or analogue, a studio camera, a motion capture device or any other device suitable to effect and implement the system and method of the invention as further disclosed herein, and the invention is not limited by the use of any such description.

As disclosed in this invention, the broadcast of the filming of the interview includes any means and/or method of delivering the filmed interview to an audience and/or viewer(s) of the filmed interview, by any suitable means and/or method, including the transmission of the filmed interview, in a wired and/or wireless manner, whether terrestrial or non-terrestrial, by known means and/or methods or future means and/or methods, including the use of television stations, transmitters, receivers, transceivers, satellite transmitters and/or receivers, wired and/or wireless networks, terrestrial and/or non-terrestrial data networks, the internet, intranets, cellular transmitters/receivers or any of the preceding means and/or methods, whether used alone or in conjunction with one another and/or in any suitable combination thereof.

A viewer(s) and/or an audience may view the transmitted interview on any of a number of suitable devices, including television monitors, mobile devices, cellular devices, tablet computers, monitors, projections, pads or the like, including the use of ancillary devices and equipment, hardware and software, such as personal video recorders, TiVo, from cable head ends and the like.

In addition, a filmed interview may be broadcast or transmitted to an audience live and/or virtually instantly and/or it may be recorded and/or stored for future transmission at a later date or delayed transmission may occur. Further, a filmed interview may be reformatted to a different medium, such as a video file to be viewed on a device or through a web browser or device or system and/or method that enable a viewer to view the filmed interview.

An interviewer 102 interviews an interviewee 103 in front of backdrop apparatus 90. The interview is often recorded by a camera/video arrangement (not shown) and transmitted to an audience as has been described herein.

As mentioned, audio pickup of the conversation between the interviewer and the interviewee is often made with the use of a microphone 104. Alternatively, the interviewer 102 is not present on screen, and only the interviewee(s) 103 is/are viewable.

Backdrop apparatus 90 includes a plurality of communication zones 105, 106, 107, 108 109, 110, from which static communications are displayed. These communication zones are visible to the audience of the transmitted interview and provide exposure of a communication to viewers of the transmitted interview.

A communication may be a message, an advertisement, a logo, a brand, a station identifier or the like.

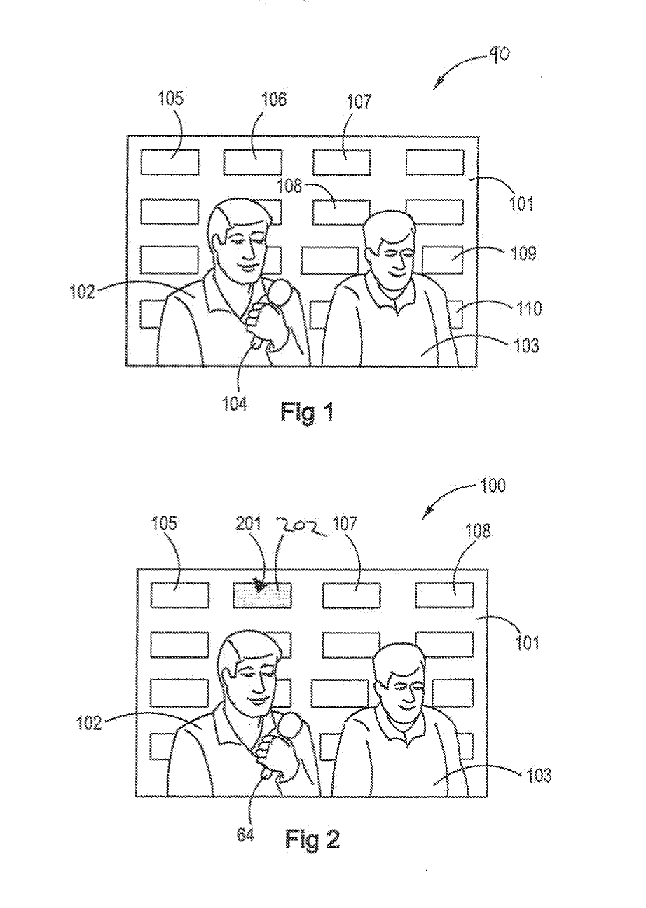

Referring now to FIG. 2, backdrop apparatus 100 in accordance with the invention comprises a plurality of communication zones 105, 107 and 108 which display static communications.

Importantly, backdrop apparatus 100 comprises at least one dynamic communication zone 201.

Dynamic communication zone 210 comprises a display device 202 characterized in that it comprises a face for displaying a variable communication.

Significantly, in a preferred embodiment, display device 202 is an electronic display device configured to display an electronically variable communication or dynamic content. Display device 202 may display at least one or a plurality of electronically variable communications, including photos and/or moving images such as videos.

Meaningfully, due to the differentiation of the face or screen 203 of display device 202 from the face of a static communication zone (105, 106, 107 and 109), a communication 204 displayed on screen 203 of electronic display device 202 will stand out from and be distinguished from a communication displayed on the face of communication zones 105, 106, 107 and 108.

Notably, due to the transmission of light from the face of electronic display device 202, a communication displayed on the face of electronic display device 202 will stand out from and be differentiated from a communication displayed on the face of a static communication zone (105, 106, 107 and 109).

Of substantial importance, when in use, electronic display device 202 is configured to display a plurality of communication and/or images therefrom, whereas a static communication zone can only display a single communication.

In use, an interview is filmed in front of the backdrop apparatus, and broadcast to an audience, electronic display device 201 can be operated to display dynamic content or electronically variable communications to an audience.

Electronic display device 202 may be permanently or removable attached to backdrop apparatus 100.

The communication zones, including zones 105, 201, 107, 108 are arranged in a geometrical pattern, which in this instance is a matrix of rows and columns.

The geometrical pattern is referenced by numeral 220 and the dashed lines. It will be appreciated by those skilled in the art that alternative geometrical patterns may be overlaid on backdrop apparatus 100, and that the communication zones will be disposed to fit in the chosen pattern or layout of the communication zones, and that the present invention is not limited to a single geometrical pattern or layout of communication zones.

The backdrop apparatus 100 comprises an at least partly planar surface and or wall. The surface and or wall may be collapsible and or portable/mobile and or transportable.

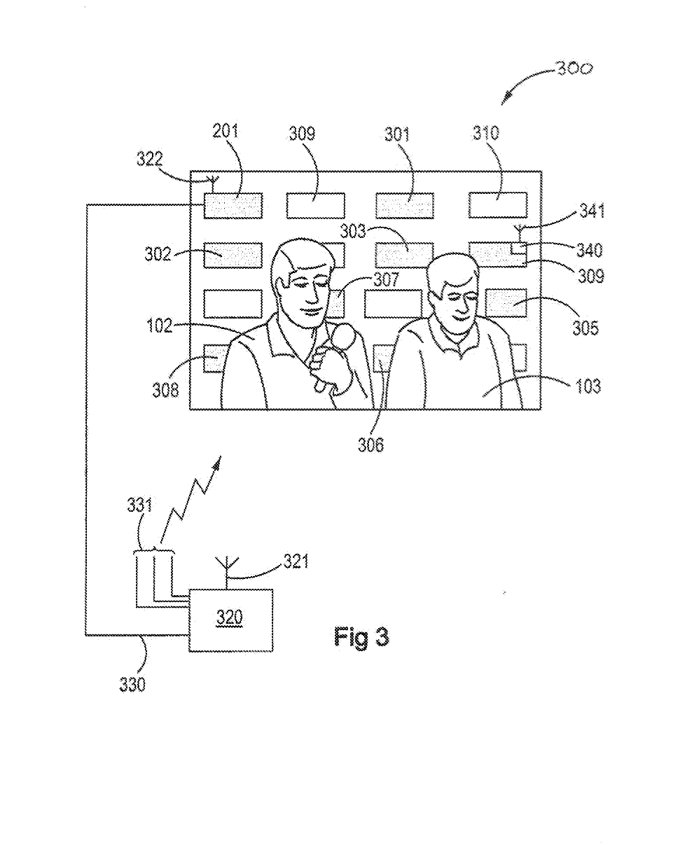

In FIG. 3 a preferred embodiment of backdrop apparatus 300 is shown. The backdrop apparatus 300 includes a plurality of electronic display devices 201, 301, 302, 303, 304, 305, 306, 307 and 308 (shaded) as well as a plurality of static display zones such as 309 and 310.

In this embodiment of the invention, the electronic display devices (shaded) are operable to display dynamic or electronically variable content.

In one preferred embodiment, the dynamic content may be controlled by a multi-channel media player 320 and the content or communication(s) on the display device(s) may be displayed in a synchronized or unsynchronized manner.

The dynamic content or electronically variable communication may be streamed from the media player 320 by cable or wireless communication channel to the screens (shaded).

In this embodiment the display devices 201, 301, 302, 303, 304, 305, 306, 307 and 308 are fed with content or communications transmitted from media player 320. Media player 320 has a transmitter (not shown) and a matched antenna 321 for transmitting the content. The display devices 201, 301, 302, 303, 304, 305, 306, 307 and 308 are thus provided with receivers (not shown) and an antenna 322 for receiving the streamed content.

Alternatively the display devices 201, 301, 302, 303, 304, 305, 306, 307 and 308 may receive content via a wired interface via at least one cable 330, connected to the media player. If required, multiple cables 331 may be provided to carry the content or communication signals.

The media player 320 may include a configurable computerized system for controlling the content or communications to be displayed on the various display devices 201, 301, 302, 303, 304, 305, 306, 307 and 308.

In an alternative embodiment (not shown), the electronic display devices may contain circuitry and controllers to connect wirelessly to the Internet and to receive and or store the necessary communications and to display the appropriate communication on the display device in accordance with a predefined schedule.

In an alternative embodiment, display devices 201, 301, 302, 303, 304, 305, 306, 307 and 308 may include a display face, a storage module, suitable drivers, batteries, electricity power supply units, associated circuitry, hardware and software such that at least one communication may be stored in an electronic display device and displayed by the electronic display device, at a predetermined time and date for a predetermined duration.

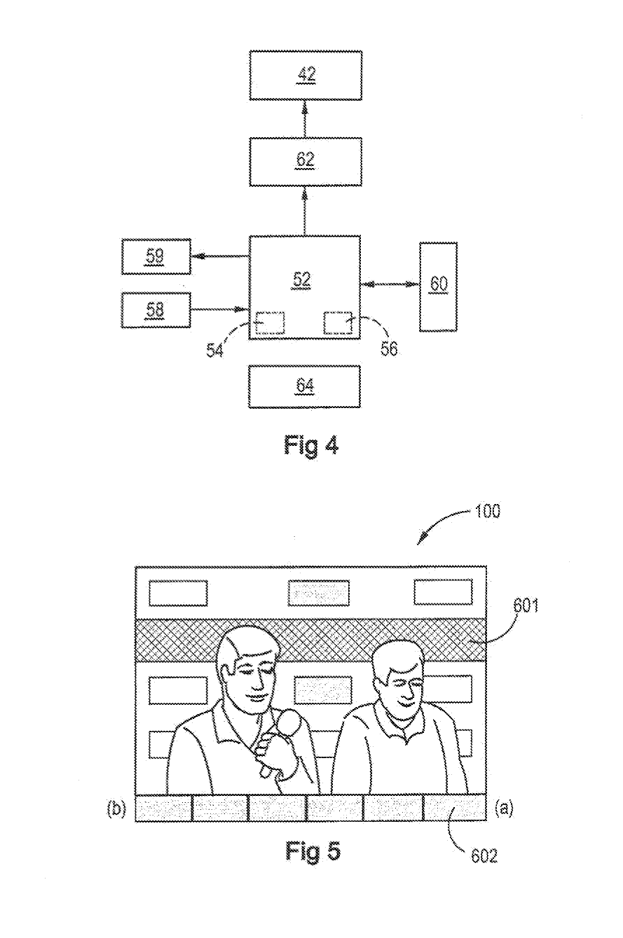

In the block diagram shown in FIG. 4 a block diagram of a display controller 50 is shown.

The display controller 50 has a computer based controller 52 with a clock 54 and a timer 56, a receiver 58, a transmitter 59, a storage module 60, a display screen 42, drivers 62 for the screen 42 and a rechargeable battery 64 or power supply source 64. Transmitter 59 may be a wireless transmitter or a cable transmitter.

The same communication streams may be displayed simultaneously on all electronic display devices, shown in FIG. 3 as 201, 301, 302, 303, 304, 305, 306, 307 and 308, or the communication steams may be displayed contemporaneously on the different electronic display devices, using signals transmitted from the controller 50 to the electronic display device.

In another embodiment, shown in FIG. 5, the studio backdrop 100 includes an electronic display device 601 that completely or substantially runs the width of the backdrop apparatus 100. At the bottom of the studio backdrop a plurality of smaller electronic display devices 602 are linearly arranged along the width of the studio backdrop 100, such that dynamic media can “scroll” from one end of the electronic display device 602 to the other.

The present invention includes a system and method and means whereby a communication or a plurality of communications from at least one communicator can stand out from the plurality of communications of at least one other communicator and/or from the plurality of communications that are typically displayed on a backdrop apparatus and then transmitted to an audience.

The ability to enable at least one communicator have at least one of their communications stand out from the other communications displayed in the backdrop apparatus is of value to such a communicator.

As further described in the invention disclosed herein, this is achieved without derogating or distracting from the general aesthetic layout of a backdrop apparatus.

In particular, press interviews with sports teams or a sports person(s) and discussions between an interviewer(s) and interviewee(s), and the like are often conducted in front of said backdrop apparatus, which display static communications thereon, which discussion is filmed, transmitted to an audience and then viewed by an audience.

The audience or viewers may view such transmission on a variety of devices including television monitors, computers, mobile devices, tablet computers or any other suitable medium or device.

The summary of invention and claims form an integral aspect of the description of the invention.

1. A backdrop apparatus for use during filming of an interview by way of an image display arrangement, the backdrop apparatus comprising:
an at least partly planar surface onto which is disposed an predetermined arrangement of communication zones which display communication data, wherein the arrangement of communication zones comprises:
at least one dynamic communication zone being operable to display a variable communication,
and
at least one static communication zone being operable to display a static communication.

2. The backdrop apparatus as claimed in claim 1, where the variable communication is an electronically variable communication.

3. The backdrop apparatus as claimed in claim 1, where the surface of the backdrop apparatus is provided on a wall.

4. The backdrop apparatus as claimed in claim 3, wherein the wall is collapsible.

5. The backdrop apparatus as claimed in claim 1, where the backdrop apparatus is either portable or fixed at a particular location.

6. The backdrop apparatus as claimed in claim 4, in which the wall is defined by any one of a substantially flat plane and a curved plane.

7. The backdrop apparatus as claimed in claim 1, in which the predetermined arrangement comprises a geometric arrangement in the form of a matrix of communication zones.

8. The backdrop apparatus as claimed in claim 7, in which the geometric display is in the form of any other type of geometric arrangement of communication zones, with at least some of the zones operable to display dynamic video content.

9. The backdrop apparatus as claimed in claim 8, in which the communication zones operable to display dynamic video include a vertical synchronization interface, operable to synchronize the vertical scan signal of the electronic display and an external video camera with each other to stabilise the vertical scan signals.

10. The backdrop apparatus as claimed in claim 1, in which the backdrop apparatus includes a computing means to receive and transmit content to at least one dynamic communication zone for display of content.

11. The backdrop apparatus as claimed in claim 10, in which multiple electronic screens are provided, and in which the content is synchronized amongst the screens.

12. The backdrop apparatus as claimed in claim 10, in which multiple electronic screens are provided, and in which the content is unsynchronized.

13. A backdrop apparatus as claimed in claim 10, in which the computing means is operable to receive content in any one of real time and from stored data files.

14. The backdrop apparatus as claimed in claim 13, in which the computing means includes a content scheduling arrangement, operable selectively to play pre-defined content at a particular time on a particular electronic screen.

15. The backdrop apparatus as claimed in claim 1, comprising at least one proximity sensor to determine the presence of a person in front of the backdrop.

16. A backdrop apparatus as claimed in claim 15, comprising a plurality of proximity sensors to indicate the position of the interviewer and interviewee relative to the backdrop; and which communication zones are most exposed to view by a camera, in use.

17. The backdrop apparatus as claimed in claim 16, wherein the position of the person detected by the proximity sensors is used to select the type and position of content displayed on at least one communication zone.

18. A backdrop apparatus as claimed in claim 1, which includes a power supply.

19. A method of filming an interview, which includes
providing a backdrop apparatus as claimed in claim 1;
arranging subjects to be recorded in front of the backdrop apparatus such that the backdrop apparatus fills a recording frame; and
filming the interview in front of the backdrop apparatus.

20. A method of filming an interview as claimed in claim 19 where the filmed interview is transmitted to an audience.

21. A method of filming an interview as claimed in claim 20 in which the backdrop apparatus fills a smaller portion of the recording frame than the full frame.

22. A method of filming an interview as claimed in claim 19, whereby at least one communication from at least one communication zone is distinguishable from a plurality of communications of at least one other communicator displaying the plurality of communications that are typically displayed on a backdrop apparatus and then transmitted to an audience.

23. A backdrop apparatus as claimed in claim 1, substantially as herein described and illustrated.
